(19) United States
(12) Patent Application Publication
(10) Pub. No.: US 2021/0349467 A1
(43) Pub. Date: Nov. 11, 2021

(54) CONTROL DEVICE, INFORMATION PROCESSING METHOD, AND PROGRAM

(71) Applicant: SONY CORPORATION, TOKYO (JP)

(72) Inventor: MASATAKA TOYOURA, TOKYO (JP)

(21) Appl. No.: 17/250,774

(22) PCT Filed: Aug. 28, 2019
(86) PCT No.: PCT/JP2019/033623

§ 371 Date: Mar. 2, 2021

(30) Foreign Application Priority Data
Sep. 11, 2018 (JP) 2018-169814

(51) Int. Cl. G05D 1/02; G01C 21/00

(52) U.S. Cl. CPC G05D 1/0246; G05D 1/0255; G01C 21/3848

(57) ABSTRACT

The present technology relates to a control device, an information processing method, and a program that are capable of planning a correct route as a movement route of a mobile object. A control device on one aspect of the present technology is a device that generates a map representing a position occupied by an object on the basis of a detection result by an optical sensor, estimates a position of a mirror-surface object that is an object having a mirror surface, and plans, in a case where presence of the mirror-surface object is estimated in a dividing section where an arrangement of predetermined objects is divided, a route that does not pass through the dividing section as a movement route of the mobile object on the basis of the map. The present technology can be applied to a mobile object such as a robot that moves autonomously.

### TECHNICAL FIELD

The present technology relates to a control device, an information processing method, and a program, and more particularly to a control device, an information processing method, and a program that are capable of planning a correct route as a movement route of a mobile object.

### BACKGROUND ART

With advances of artificial intelligence (AI) and the like, robots that move autonomously according to a surrounding environment are becoming widespread.

Planning of a movement route by such an autonomous mobile robot is generally performed by creating a map by measuring the distances to surrounding obstacles with a sensor and is performed on the basis of the created map. As the sensor used for creating the map, an optical system distance sensor that measures the distance by an optical mechanism, such as a light detection and ranging (LiDAR) sensor and a time-of-flight (ToF) sensor, is used.

### CITATION LIST

### Patent Document

Patent Document 1: Japanese Patent Application Laid-Open No. 2015-001820

Patent Document 2: Japanese Patent Application Laid-Open No. 2009-244965

### SUMMARY OF THE INVENTION

### Problems to be Solved by the Invention

In a case of measuring a distance using the optical system distance sensor, if there is a mirror-like object whose surface is a mirror surface, a map different from the actual situation may be created. Due to reflection of light emitted by the optical system distance sensor, the autonomous mobile robot cannot recognize that the mirror is there from a measurement result targeting at the position of the mirror.

That is, the autonomous mobile robot cannot distinguish between the space reflected on the mirror and the real space, and may plan a route to move in the space reflected on the mirror as a movement route.

In order for the autonomous mobile robot to enter a human living environment, it is necessary for the autonomous mobile robot to be able to correctly determine that the space reflected in the mirror is a space where it is not possible to move.

The present technology has been made in view of such a situation, and makes it possible to plan a correct route as a movement route of a mobile object.

### Solutions to Problems

A control device of one aspect of the present technology includes a map generation unit that generates a map representing a position occupied by an object on the basis of a detection result by an optical sensor, an estimation unit that estimates a position of a mirror-surface object that is an object having a mirror surface, and a route planning unit that plans, in a case where presence of the mirror-surface object is estimated in a dividing section where an arrangement of predetermined objects is divided, a route that does not pass through the dividing section as a movement route of the mobile object on the basis of the map.

A control device of another aspect of the present technology includes a map generation unit that generates a map representing a position occupied by an object on the basis of a detection result by an optical sensor, an estimation unit that estimates a position of a transparent object, which is an object having a transparent surface, on the basis of a detection result by another sensor that measures a distance to an object by a method different from a method used by the optical sensor, and a route planning unit that plans, in a case where presence of the transparent object is estimated in a dividing section where an arrangement of predetermined objects is divided, a route that does not pass through the dividing section as a movement route of the mobile object on the basis of the map.

In one aspect of the present technology, a map representing a position occupied by an object is generated on the basis of a detection result by an optical sensor, and a position of a mirror-surface object that is an object having a mirror surface is estimated. Furthermore, in a case where presence of the mirror-surface object is estimated in a dividing section where an arrangement of predetermined objects is divided, a route that does not pass through the dividing section is planned as a movement route of the mobile object on the basis of the map.

In another aspect of the present technology, a map representing a position occupied by an object is generated on the basis of a detection result by an optical sensor, and a position of a transparent object, which is an object having a transparent surface, is estimated on the basis of a detection result by another sensor that measures a distance to an object by a method different from a method used by the optical sensor. Furthermore, in a case where presence of the transparent object is estimated in a dividing section where an arrangement of predetermined objects is divided, a route that does not pass through the dividing section as a movement route of the mobile object is planned on the basis of the map.

### BRIEF DESCRIPTION OF DRAWINGS

FIG. 1 is a diagram illustrating an example of an appearance of a mobile object according to an embodiment of the present technology.

FIG. 2 is a view illustrating an example of a situation around the mobile object.

FIG. 3 is a diagram illustrating an example of an occupancy grid map.

FIG. 4 is a diagram illustrating an example of a movement route.

FIG. 5 is a diagram illustrating an example of the occupancy grid map after correction.

FIG. 6 is a diagram illustrating another example of the movement route.

FIG. 7 is a block diagram illustrating a hardware configuration example of the mobile object.

FIG. 8 is a flowchart describing a process of the mobile object.

FIG. 9 is a diagram illustrating an example of a first method for estimating a position of a mirror.

FIG. 10 is a block diagram illustrating a functional configuration example of a control unit.

FIG. 11 is a flowchart describing a mirror position estimation process performed in step S3 of FIG. 8.

FIG. 12 is a diagram illustrating an example of a second method for estimating the position of the mirror.

FIG. 13 is a block diagram illustrating a functional configuration example of the control unit.

FIG. 14 is a flowchart describing the mirror position estimation process performed in step S3 of FIG. 8.

FIG. 15 is a diagram illustrating an example of a third method for estimating the position of the mirror.

FIG. 16 is a block diagram illustrating a functional configuration example of the control unit.

FIG. 17 is a flowchart describing the mirror position estimation process performed in step S3 of FIG. 8.

FIG. 18 is a diagram illustrating an example of a fourth estimation method for the position of the mirror.

FIG. 19 is a block diagram illustrating a functional configuration example of the control unit.

FIG. 20 is a flowchart describing the mirror position estimation process performed in step S3 of FIG. 8.

FIG. 21 is a diagram illustrating an example of correction of the occupancy grid map.

FIG. 22 is a diagram illustrating an example of restoration of the occupancy grid map.

FIG. 23 is a diagram illustrating a configuration example of a control system.

FIG. 24 is a block diagram illustrating a configuration example of a computer.

### MODE FOR CARRYING OUT THE INVENTION

Hereinafter, a mode for carrying out the present technology will be described. The description will be made in the following order.

1. Route planning based on occupancy grid map

2. Configuration example of mobile object

3. Overall processing of mobile object

4. Example of estimating position of mirror on basis of prior information

5. Example of integrating sensor outputs to estimate position of mirror

6. Example of estimating position of mirror using marker

7. Example of estimating position of mirror by template matching

8. Correction of occupancy grid map

9. Other examples

### Route Planning Based on Occupancy Grid Map

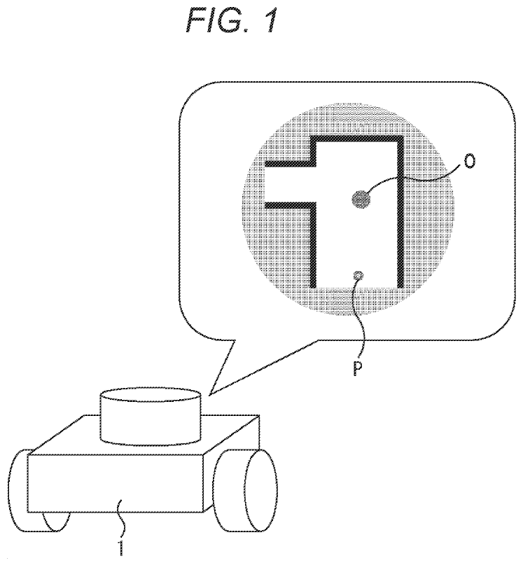

FIG. 1 is a diagram illustrating an example of appearance of a mobile object according to an embodiment of the present technology.

A mobile object 1 illustrated in FIG. 1 is a mobile object capable of moving to an arbitrary position by driving wheels provided on side surfaces of a box-shaped housing. Various sensors such as a camera and a distance sensor are provided at predetermined positions of a columnar unit provided on an upper surface of the box-shaped housing.

The mobile object 1 executes a predetermined program by an incorporated computer and takes an autonomous action by driving each part such as a wheel.

Instead of the mobile object 1, a dog-shaped robot may be used, or a human-shaped robot capable of bipedal walking may be used. It is possible to allow various autonomously mobile objects, such as what are called drones, which are aircraft capable of performing unmanned flight, to be used in place of the mobile object 1.

A movement route to a destination is planned on the basis of an occupancy grid map as illustrated in a balloon. The occupancy grid map is map information in which a map representing the space in which the mobile object 1 exists is divided into a grid shape, and information indicating whether or not an object exists is associated with each cell. The occupancy grid map indicates the position occupied by the object.

When the map information managed by the mobile object 1 is visualized, the occupancy grid map is represented as a two-dimensional map as illustrated in FIG. 1. A small circle at a position P represents the position of the mobile object 1, and a large circle in front of (above) the mobile object 1 represents an object O that becomes an obstacle during movement. A thick line indicates that predetermined objects such as wall surfaces are lined up in a straight line.

An area represented in white surrounded by thick lines is the area where the mobile object 1 can move without any obstacles. The area illustrated in light color outside the thick lines is an unknown area where the situation cannot be measured.

The mobile object 1 creates the occupancy grid map by constantly measuring distances to objects in surroundings using a distance sensor, plans the movement route to a destination, and actually moves according to the planned movement route.

The distance sensor of the mobile object 1 is an optical system distance sensor that measures a distance by an optical mechanism such as a light detection and ranging (LiDAR) sensor and a time-of-flight (ToF) sensor. The measurement of distance by the optical system distance sensor is performed by detecting a reflected light of an emitted light. The distance may also be measured using a stereo camera or the like.

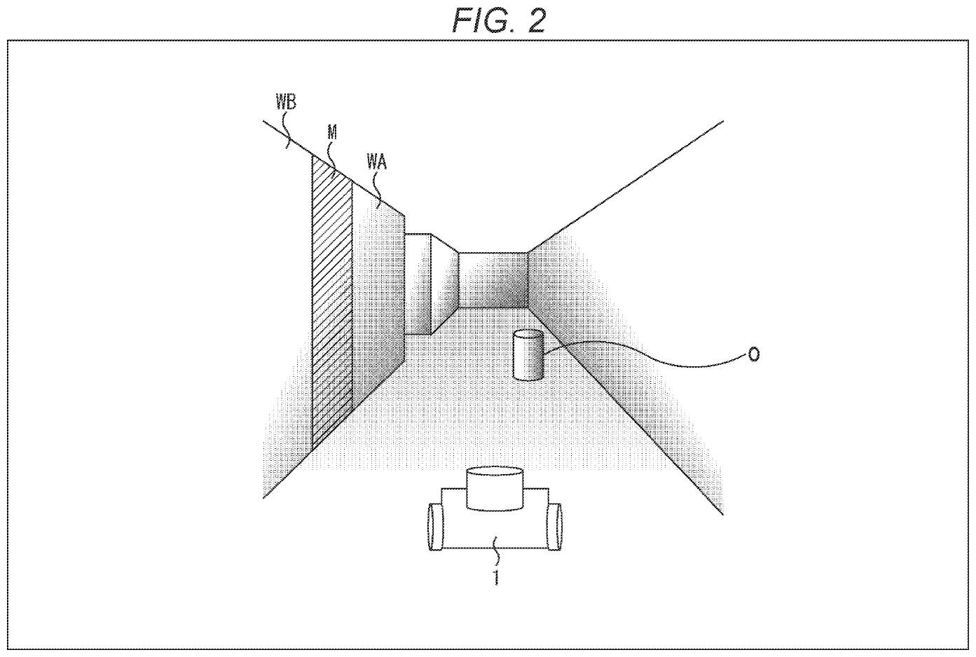

FIG. 2 is a view illustrating an example of a situation around the mobile object 1.

As illustrated in FIG. 2, it is assumed a case where the mobile object 1 is in a passage where an end is a dead end and a left turn is possible in front thereof. There are walls along the passage, and the columnar object O is placed forward. It is assumed that the destination of the mobile object 1 is a position at an end after turning left at the front corner.

A mirror M is provided on the wall on a left front side of the mobile object 1 and in front of the passage that turns to the left, as indicated by oblique lines. The mirror M is provided so as to form a surface continuous with a wall WA forming a wall surface on the right side when facing the mirror M and a wall WB forming a wall surface on the left side.

In a case where the distance is measured with respect to the position of the mirror M in such a situation, a light emitted by the optical system distance sensor is reflected by the mirror M. In the mobile object 1, the distance is measured on the basis of the reflected light, and the occupancy grid map is generated.

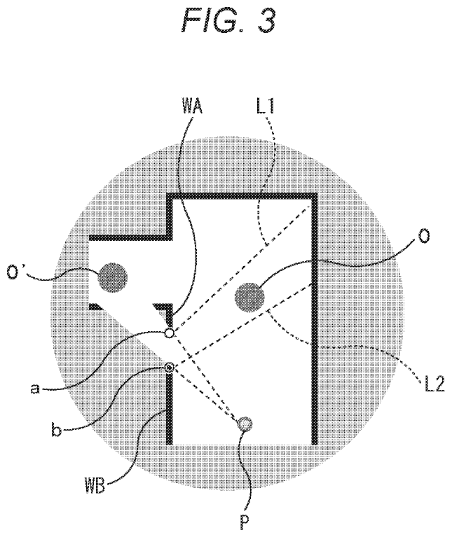

FIG. 3 is a diagram illustrating an example of the occupancy grid map.

In FIG. 3, an end point a represents a boundary between the wall WA and the mirror M, and an end point b represents a boundary between the wall WB and the mirror M. The mirror M is actually present between the end point a and the end point b. The light from the optical system distance sensor targeting at the position of the mirror M is reflected by the mirror M toward the range indicated by broken lines L1 and L2.

In this case, assuming that processing such as correction as described later is not performed, on the occupancy grid map generated by the mobile object 1, there is a movable area beyond the mirror M, and an object O′ is present ahead of the area. The movable area and the object O′ beyond the mirror M represent a situation different from the situation in the real space. Note that the object O′ is arranged on the occupancy grid map on the basis of that the object O is present in the range of a reflection vector indicated by the broken lines L1 and L2.

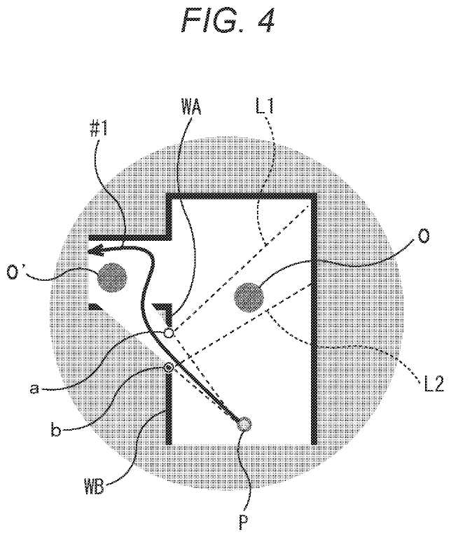

In a case where the route is planned on the basis of the occupancy grid map illustrated in FIG. 3, the movement route is set as a route as indicated by arrow #1 in FIG. 4 passing beyond the mirror M. In a case where the mobile object 1 moves according to the movement route illustrated in FIG. 4, the mobile object 1 will collide with the mirror M.

In the mobile object 1, the following processing is mainly performed in order to suppress influence of a false detection of the optical system distance sensor on the route planning in the environment with a mirror.

1. Processing of estimating position of mirror on basis of detection results of various sensors, and the like

2. Processing of correcting occupancy grid map on basis of estimation result of mirror position

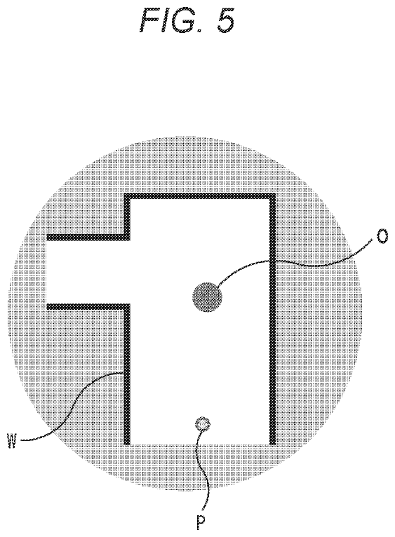

FIG. 5 is a diagram illustrating an example of the occupancy grid map after correction.

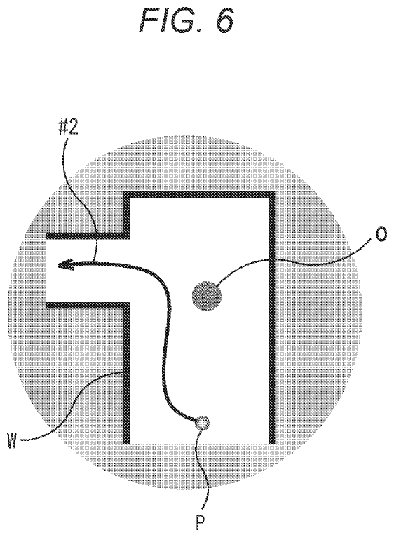

In the example of FIG. 5, the occupancy grid map is corrected so that the mirror M is treated as a wall W integrated with the left and right walls WA and WB. In a case where the route is planned on the basis of the occupancy grid map illustrated in FIG. 5, the movement route is set as a route as indicated by arrow #2 in FIG. 6, which turns left at the corner beyond the mirror M.

By estimating the position of the mirror and correcting the occupancy grid map on the basis of the estimation result in this manner, the mobile object 1 can perform the route planning on the basis of the correct occupancy grid map representing the actual situation. The mobile object 1 can plan a correct route as the movement route of the mobile object.

A series of processes of the mobile object 1 including estimation of the position of the mirror will be described later with reference to a flowchart.

### Configuration Example of Mobile Object

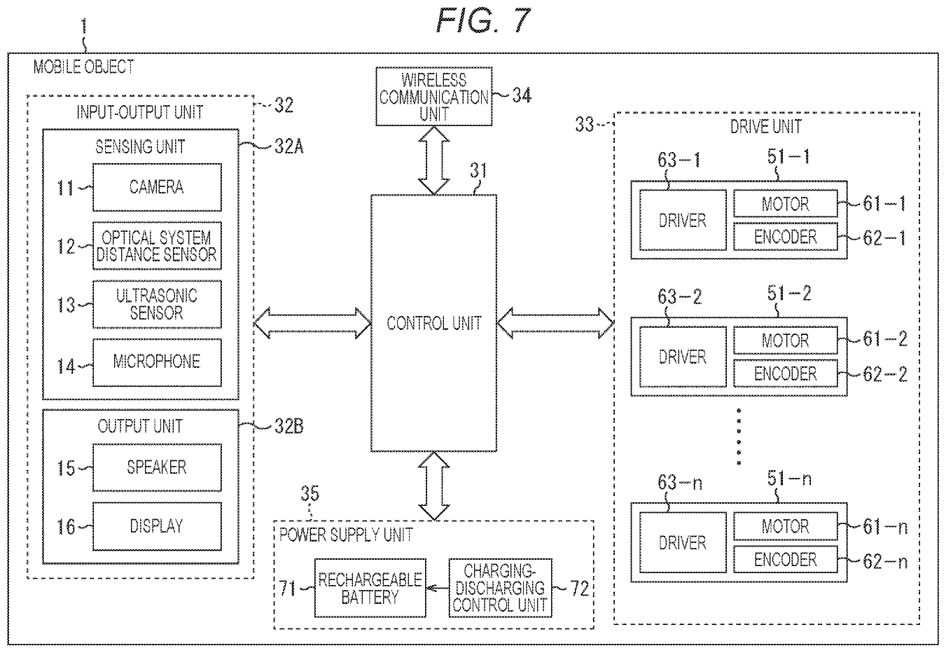

FIG. 7 is a block diagram illustrating a hardware configuration example of the mobile object 1.

As illustrated in FIG. 7, the mobile object 1 is configured by connecting an input-output unit 32, a drive unit 33, a wireless communication unit 34, and a power supply unit 35 to a control unit 31.

The control unit 31 includes a computer having a central processing unit (CPU), a read only memory (ROM), a random access memory (RAM), a flash memory, and the like. The control unit 31 executes a predetermined program by the CPU and controls the entire operation of the mobile object 1. The computer constituting the control unit 31 is mounted in the housing of the mobile object 1, for example, and functions as a control device for controlling operation of the mobile object 1.

For example, the control unit 31 generates the occupancy grid map on the basis of the distance information supplied from the optical system distance sensor 12 of the input-output unit 32. Furthermore, the control unit 31 plans a movement route to a predetermined destination on the basis of the occupancy grid map.

Furthermore, the control unit 31 controls each unit of the drive unit 33 so as to take a predetermined action such as moving to a destination.

The input-output unit 32 includes a sensing unit 32A and an output unit 32B.

The sensing unit 32A includes a camera 11, an optical system distance sensor 12, an ultrasonic sensor 13, and a microphone (microphone) 14.

The camera 11 sequentially captures an image of surrounding conditions and outputs an image obtained by the image-capturing to the control unit 31. If the characteristics of the object can be captured, various types of sensors such as an RGB sensor, a grayscale sensor, an infrared sensor, and the like can be used as the image sensor of the camera 11.

The optical system distance sensor 12 measures the distance to an object by an optical mechanism, and outputs information indicating the measured distance to the control unit 31. Measurement of the distance by the optical system distance sensor 12 is performed, for example, for 360° around the mobile object 1.

The ultrasonic sensor 13 transmits ultrasonic waves to an object and receives reflected waves therefrom to measure presence or absence of the object and the distance to the object. The ultrasonic sensor 13 outputs information indicating the measured distance to the control unit 31.

The microphone 14 detects environmental sounds and outputs data of the environmental sounds to the control unit 31.

The output unit 32B includes a speaker 15 and a display 16.

The speaker 15 outputs a predetermined sound such as synthetic voice, sound effect, and BGM.

The display 16 includes, for example, an LCD, an organic EL display, or the like. The display 16 displays various images under control of the control unit 31.

The drive unit 33 is driven according to control by the control unit 31 to implement an action of the mobile object 1. The drive unit 33 includes a driving unit for driving wheels provided on side surfaces of the housing, a driving unit provided for each joint, and the like.

Each driving unit includes a combination of a motor that rotates around an axis, an encoder that detects the rotation position of the motor, and a driver that adaptively controls the rotation position and rotation speed of the motor on the basis of output of the encoder. The hardware configuration of the mobile object 1 is determined by the number of driving units, the positions of the driving units, and the like.

In the example of FIG. 7, driving units 51-1 to 51-n are provided. For example, the driving unit 51-1 includes a motor 61-1, an encoder 62-1, and a driver 63-1. The driving units 51-2 to 51-n also have a configuration similar to the driving unit 51-1. Hereinafter, in a case where it is not necessary to distinguish the driving units 51-2 to 51-n, they will be collectively referred to as the driving unit 51 as appropriate.

The wireless communication unit 34 is a wireless communication module such as a wireless LAN module and a mobile communication module compatible with Long Term Evolution (LTE). The wireless communication unit 34 communicates with an external device such as a server on the Internet.

The power supply unit 35 supplies power to each unit in the mobile object 1. The power supply unit 35 includes a rechargeable battery 71 and a charging-discharging control unit 72 that manages a charging-discharging state of the rechargeable battery 71.

### Overall Processing of Mobile Object

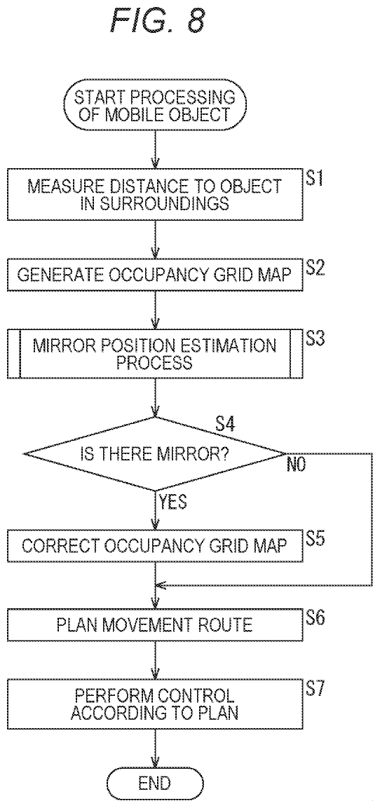

Processing of the mobile object 1 will be described with reference to a flowchart of FIG. 8.

In step S1, the control unit 31 controls the optical system distance sensor 12 and measures the distance to an object in surroundings.

In step S2, the control unit 31 generates the occupancy grid map on the basis of a measurement result of the distance. In a case where a mirror is present in surroundings of the mobile object 1, at this point, the occupancy grid map is generated that represents a situation different from the real space situation as described with reference to FIG. 3.

In step S3, the control unit 31 performs a mirror position estimation process. The mirror position estimation process estimates the position of a mirror that is present in the surroundings. Details of the mirror position estimation process will be described later.

In step S4, the control unit 31 corrects the occupancy grid map on the basis of the estimated mirror position. Thus, an occupancy grid map representing that a predetermined object is present at the position where presence of the mirror is estimated is generated as described with reference to FIG. 5.

In step S6, the control unit 31 plans a movement route on the basis of the occupancy grid map after correction.

In step S7, the control unit 31 controls each of the units including the driving unit 51 according to the plan of the movement route, and causes the mobile object 1 to move.

Hereinafter, the mirror position estimation process will be described. There are the following methods for estimating the position of a mirror.

1. Example of estimating position of mirror on basis of prior information

2. Example of integrating sensor outputs to estimate position of mirror

3. Example of estimating position of mirror using marker

4. Example of estimating position of mirror by template matching

### Example of Estimating Position of Mirror on Basis of Prior Information

### Method for Estimating Position of Mirror

In this example, information indicating the position of a mirror is given to the mobile object 1 in advance, and the position of the mirror is estimated on the basis of the information given in advance. The position of the mirror is represented by, for example, a start position and an end position (end point) of the mirror in the space where the mobile object 1 exists.

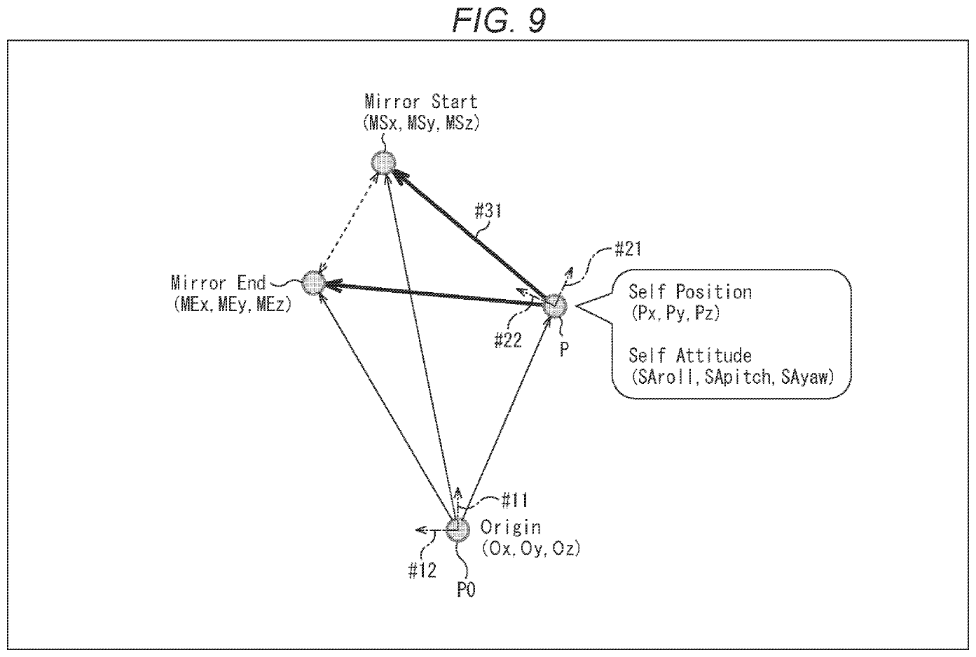

FIG. 9 is a diagram illustrating an example of a method for estimating the position of a mirror.

An origin PO illustrated in FIG. 9 is an origin as a reference in the space where the mobile object 1 exists. Coordinates of the origin PO are expressed as, for example, coordinates (Ox, Oy, Oz). Each position in the space where the mobile object 1 exists is represented by coordinates with reference to the origin PO.

Coordinates representing a start position (Mirror Start) of the mirror and coordinates representing an end position (Mirror End) of the mirror are given to the mobile object 1. In the example of FIG. 3 described above, the start position of the mirror corresponds to, for example, the end point a, and the end position of the mirror corresponds to, for example, the end point b. In the example of FIG. 9, the start position of the mirror is represented by coordinates (MSx, MSy, MSz), and the end position is represented by coordinates (MEx, MEy, MEz).

The position P is the current position of the mobile object 1. The position P is identified by a position identification function of the mobile object 1. The position P is represented by coordinates (Px, Py, Pz). Furthermore, an attitude of the mobile object 1 is represented by angles with respect to respective directions of roll, pitch, and yaw.

Note that arrows #11 and #21 depicted by alternate long and short dash arrows indicate front directions of the housing of the mobile object 1. Arrows #12 and #22 indicate directions of a left side surface of the housing of the mobile object 1.

In a case where a relationship among the positions has the relationship illustrated in FIG. 9, it is estimated that a mirror is present in a section of a dashed arrow illustrated at tips of a vector #31 and a vector #32 with reference to the position P. Because the start position, end position, and coordinates of the position P of the mirror are specified with reference to the origin PO, it becomes possible to estimate the position of the mirror with reference to the position P as illustrated as the vectors #31 and #32.

In this manner, it is possible to estimate the position of the mirror on the basis of the information given in advance and correct the occupancy grid map.

### Configuration Example of Control Unit

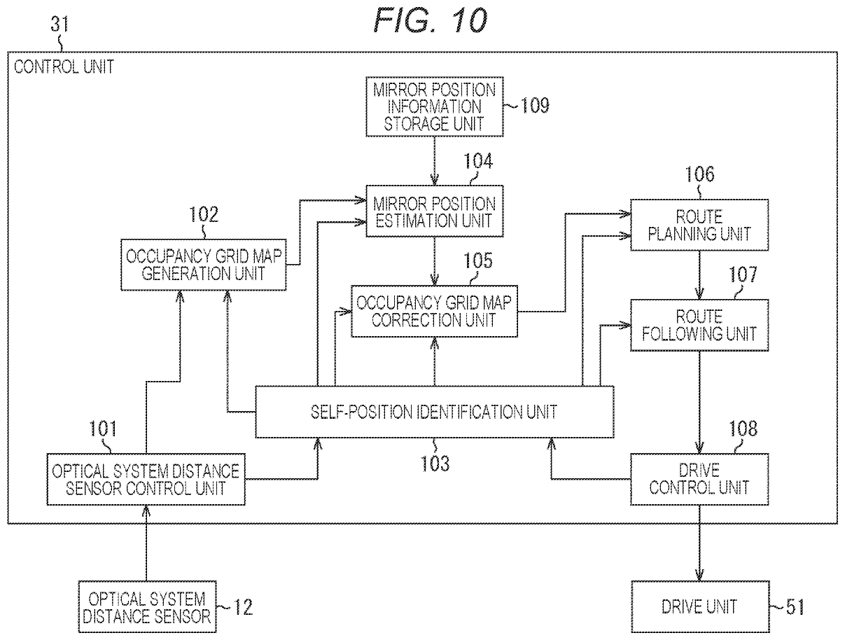

FIG. 10 is a block diagram illustrating a functional configuration example of the control unit 31 that estimates the position of a mirror on the basis of the information given in advance.

As illustrated in FIG. 10, the control unit 31 includes an optical system distance sensor control unit 101, an occupancy grid map generation unit 102, a self-position identification unit 103, a mirror position estimation unit 104, an occupancy grid map correction unit 105, a route planning unit 106, a route following unit 107, a drive control unit 108, and a mirror position information storage unit 109.

The optical system distance sensor control unit 101 controls the optical system distance sensor 12 and measures the distance to an object in surroundings. Information indicating a measurement result of distance is output to the occupancy grid map generation unit 102 and the self-position identification unit 103. The process of step S1 in FIG. 8 described above is performed by the optical system distance sensor control unit 101.

The occupancy grid map generation unit 102 generates the occupancy grid map on the basis of the measurement result supplied from the optical system distance sensor control unit 101. Furthermore, the occupancy grid map generation unit 102 sets the current position of the mobile object 1 identified by the self-position identification unit 103 on the occupancy grid map. The occupancy grid map generated by the occupancy grid map generation unit 102 is output to the mirror position estimation unit 104. The process of step S2 in FIG. 8 is performed by the occupancy grid map generation unit 102.

The self-position identification unit 103 identifies a self-position, which is the current position of the mobile object 1, on the basis of information supplied from the optical system distance sensor control unit 101 and information supplied from the drive control unit 108. Information indicating, for example, the amount of rotation of the wheels and the direction of movement is supplied from the drive control unit 108.

The self-position may be identified by a positioning sensor such as a GPS sensor. Information indicating the self-position identified by the self-position identification unit 103 is output to the occupancy grid map generation unit 102, the mirror position estimation unit 104, the occupancy grid map correction unit 105, the route planning unit 106, and the route following unit 107.

The mirror position estimation unit 104 reads and acquires information indicating the position of the mirror from the mirror position information storage unit 109. The mirror position estimation unit 104 estimates the position of the mirror with reference to the self-position as described with reference to FIG. 9 on the basis of the position of the mirror represented by the information read from the mirror position information storage unit 109, the self-position identified by the self-position identification unit 103, and the like.

Information indicating the position of the mirror estimated by the mirror position estimation unit 104 is output to the occupancy grid map correction unit 105 together with the occupancy grid map. The process of step S3 in FIG. 8 is performed by the mirror position estimation unit 104.

The occupancy grid map correction unit 105 corrects a position on the occupancy grid map where presence of the mirror is estimated by the mirror position estimation unit 104.

For example, the occupancy grid map correction unit 105 corrects the occupancy grid map so as to delete an area that is beyond the mirror and is set as a movable area. Furthermore, the occupancy grid map correction unit 105 corrects the occupancy grid map by setting information indicating that a predetermined object is present at the position where presence of the mirror is estimated.

The occupancy grid map after correction is output to the route planning unit 106. The process of step S5 in FIG. 8 is performed by the occupancy grid map correction unit 105.

The route planning unit 106 plans a movement route from the self-position identified by the self-position identification unit 103 to a predetermined destination on the basis of the occupancy grid map after correction generated by the occupancy grid map correction unit 105. By using the occupancy grid map after correction, a route that does not pass through the position of the mirror is planned as the movement route. Information of the movement route is output to the route following unit 107. The process of step S6 in FIG. 8 is performed by the route planning unit 106.

The route following unit 107 controls the drive control unit 108 so as to cause movement according to the movement route planned by the route planning unit 106. The process of step S7 in FIG. 8 is performed by the route following unit 107.

The drive control unit 108 controls the motor and the like constituting the driving unit 51 and causes the mobile object 1 to move according to the control by the route following unit 107.

The mirror position information storage unit 109 stores mirror position information, which is information indicating the position of the mirror that is measured in advance.

### Mirror Position Estimation Process

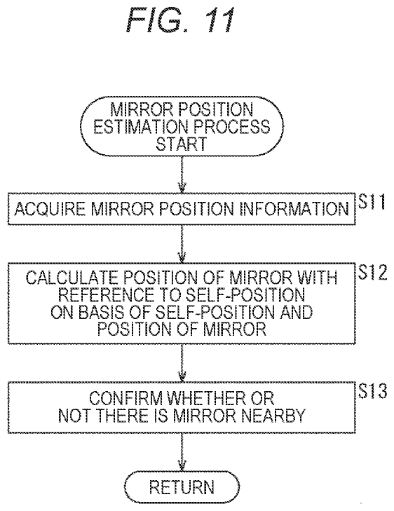

The mirror position estimation process performed in step S3 of FIG. 8 will be described with reference to a flowchart of FIG. 11. The process of FIG. 11 is a process of estimating the position of a mirror on the basis of the information given in advance.

In step S11, the mirror position estimation unit 104 reads and acquires the mirror position information from the mirror position information storage unit 109.

In step S12, the mirror position estimation unit 104 calculates the position of the mirror with reference to the self-position on the basis of the self-position and the position of the mirror represented by the mirror position information.

In step S13, the mirror position estimation unit 104 confirms whether or not a mirror is present near the self-position. In a case where the mirror is present near the self-position, information indicating the position of the mirror is output to the occupancy grid map correction unit 105.

Thereafter, the process returns to step S3 in FIG. 8 and processing in step S3 and subsequent steps is performed.

As described above, because the information indicating the position of the mirror is given in advance, the mobile object 1 can estimate the position of the mirror and correct the occupancy grid map.

### Example of Integrating Sensor Outputs to Estimate Position of Mirror

### Method for Estimating Position of Mirror

In this example, not only the occupancy grid map based on the measurement result by the optical system distance sensor 12, but also the occupancy grid map based on the measurement result by the ultrasonic sensor 13 is generated. Furthermore, the position of a mirror is estimated by integrating the occupancy grid map based on the measurement result by the optical system distance sensor 12 and the occupancy grid map based on the measurement result by the ultrasonic sensor 13. The integration of the occupancy grid maps is performed, for example, by superimposing the two occupancy grid maps or by comparing the two occupancy grid maps.

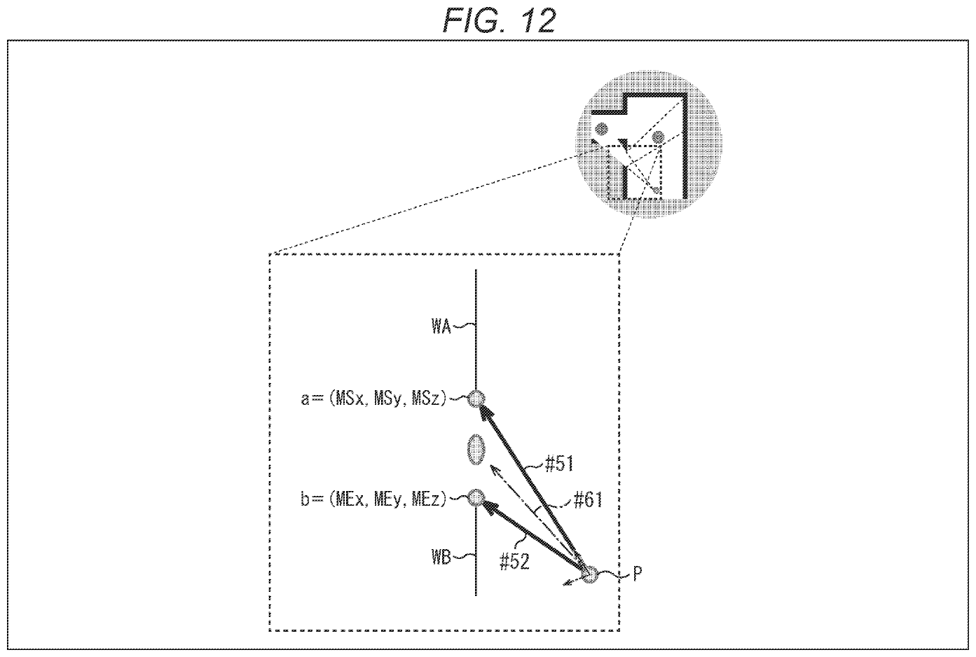

FIG. 12 is a diagram illustrating an example of a method for estimating the position of the mirror.

On the occupancy grid map based on the measurement result by the optical system distance sensor 12, as described above, the walls WA and WB, the end point a that is a boundary between the wall WA and the mirror M, and the end point b that is a boundary between the wall WB and the mirror M are indicated. The end point a is represented by a vector #51 and the end point b is represented by a vector #52 with reference to the position P that is the self-position.

From the occupancy grid map based on the measurement result by the optical system distance sensor 12, it is recognized that there is no object between the end point a and the end point b, and there is a movable area beyond that.

The mobile object 1 detects a dividing section, which is a section in which objects (walls WA and WB) lined up on a straight line are divided, such as a section between the end point a and the end point b, from the occupancy grid map based on the measurement result by the optical system distance sensor

Furthermore, the mobile object 1 confirms whether or not an object is present in the section on the occupancy grid map based on the measurement result by the ultrasonic sensor 13, the section corresponding to the dividing section.

As illustrated ahead of a vector #61 in FIG. 12, in a case where it is confirmed from the occupancy grid map based on the measurement result by the ultrasonic sensor 13 that the predetermined object is present at the position corresponding to the dividing section, the mobile object 1 recognizes that a mirror is present in the dividing section.

In this manner, in a case where there is a response to the ultrasonic sensor 13 in the dividing section on the occupancy grid map based on the measurement result by the optical system distance sensor 12, the mobile object 1 recognizes that a mirror is present in the dividing section, and estimates the position of the mirror.

The ultrasonic sensor 13 is a sensor capable of measuring the distance to the mirror similarly to the distance to another object. Spatial resolution of the ultrasonic sensor 13 is generally low, and thus the mobile object 1 cannot generate a highly accurate occupancy grid map only from the measurement result by the ultrasonic sensor 13. Normally, the occupancy grid map using the ultrasonic sensor 13 becomes a map with a coarser grain size than the occupancy grid map using the optical system distance sensor 12.

On the other hand, the optical system distance sensor 12, which is an optical system sensor such as a LiDAR or ToF sensor, is a sensor that can measure the distance to an object such as a wall existing on both sides of the mirror with high spatial resolution, but that cannot measure the distance to the mirror itself.

By generating two occupancy grid maps using the optical system distance sensor 12 and the ultrasonic sensor 13 and using them in an integrated manner, the mobile object 1 is capable of estimating the position of the mirror.

As long as it is a sensor that measures the distance to the object by a method different from the method used by the optical system distance sensor 12, another sensor can be used instead of the ultrasonic sensor 13. For example, a stereo camera may be used, or a sensor that receives a reflected wave of a transmitted radio wave and measures the distance may be used.

### Configuration Example of Control Unit

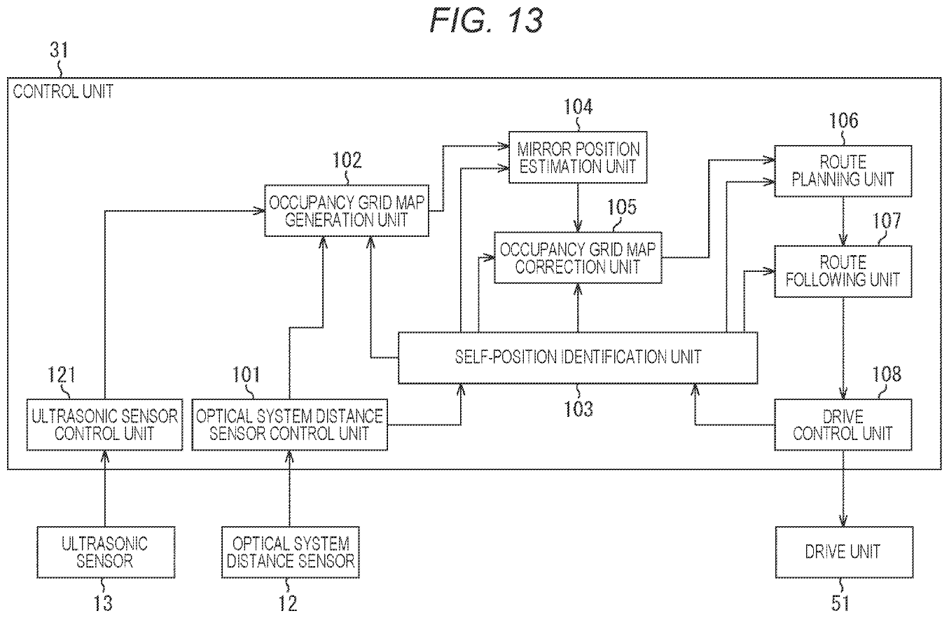

FIG. 13 is a block diagram illustrating a functional configuration example of the control unit 31.

The configuration of the control unit 31 illustrated in FIG. 13 is different from the configuration illustrated in FIG. 10 in that an ultrasonic sensor control unit 121 is provided instead of the mirror position information storage unit 109. Among components illustrated in FIG. 13, the same components as those illustrated in FIG. 10 are designated by the same reference numerals. Duplicate descriptions will be omitted as appropriate.

The ultrasonic sensor control unit 121 controls the ultrasonic sensor 13 and measures the distance to an object in surroundings. Information indicating a measurement result by the ultrasonic sensor control unit 121 is output to the occupancy grid map generation unit 102.

The occupancy grid map generation unit 102 generates the occupancy grid map on the basis of the measurement result supplied from the optical system distance sensor control unit 101. Furthermore, the occupancy grid map generation unit 102 generates the occupancy grid map on the basis of the measurement result supplied from the ultrasonic sensor control unit 121.

The occupancy grid map generation unit 102 integrates the two occupancy grid maps to thereby generate one occupancy grid map. The occupancy grid map generation unit 102 retains information indicating by which sensor an object present at each position (each cell) of the occupancy grid map after integration is detected. The occupancy grid map generated by the occupancy grid map generation unit 102 is output to the mirror position estimation unit 104.

The mirror position estimation unit 104 detects the dividing section, which is a section between the end points of the wall, from the occupancy grid map generated by the occupancy grid map generation unit 102. The detection of the dividing section is performed so as to select a section in which one straight line section, where the objects are lined up, and the other straight line section are on the same straight line and which is divided between them.

The mirror position estimation unit 104 confirms whether or not presence of a predetermined object has been detected by the ultrasonic sensor 13 in the dividing section on the basis of the occupancy grid map. In a case where the presence of the predetermined object has been detected by the ultrasonic sensor 13 in the dividing section, the mirror position estimation unit 104 recognizes that a mirror is present in the dividing section and estimates the position of the mirror. Information indicating the position of the mirror estimated by the mirror position estimation unit 104 is supplied to the occupancy grid map correction unit 105 together with the occupancy grid map.

### Mirror Position Estimation Process

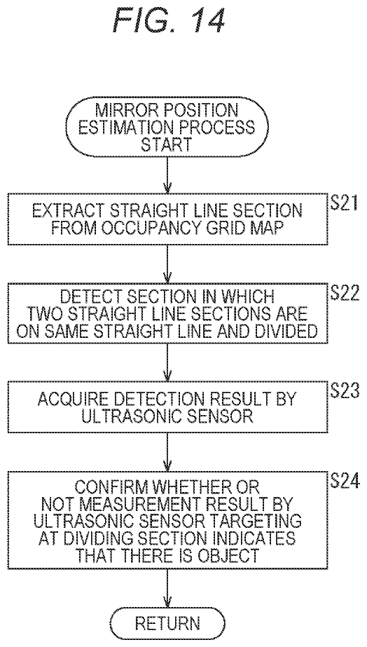

The mirror position estimation process performed in step S3 of FIG. 8 will be described with reference to a flowchart of FIG. 14. The process of FIG. 14 is a process of estimating the position of the mirror by integrating sensor outputs.

In step S21, the mirror position estimation unit 104 extracts a straight line section from the occupancy grid map generated by the occupancy grid map generation unit 102. For example, a section in which objects are lined up for equal to or longer than a length as a threshold is extracted as the straight line section.

In step S22, the mirror position estimation unit 104 detects as the dividing section a section in which one straight line section and the other straight line section are on the same straight line and which is divided between them.

In step S23, the mirror position estimation unit 104 acquires information indicating the position of the object detected by the ultrasonic sensor 13 from the occupancy grid map.

In step S24, the mirror position estimation unit 104 confirms whether or not the measurement result by the ultrasonic sensor 13 targeting at the dividing section indicates that an object is present. In a case where the measurement result by the ultrasonic sensor 13 indicates that an object is present, the mirror position estimation unit 104 recognizes that a mirror is present in the dividing section. In a case where the mirror is present near the self-position, information indicating the position of the mirror is output to the occupancy grid map correction unit 105.

Thereafter, the process returns to step S3 in FIG. 8 and processing in step S3 and subsequent steps is performed.

As described above, the mobile object 1 can estimate the position of the mirror and corrects the occupancy grid map by integrating and using the occupancy grid map based on the measurement result by the optical system distance sensor 12 and the occupancy grid map based on the measurement result by the ultrasonic sensor 13.

### Example of Estimating Position of Mirror using Marker

### Method for Estimating Position of Mirror

In this example, a marker is attached to a predetermined position on the housing of the mobile object 1. For example, an identifier such as a one-dimensional code or a two-dimensional code is used as a marker. A sticker representing the marker may be attached to the housing, or the marker may be printed on the housing. The marker may be displayed on the display 16.

The mobile object 1 analyzes an image captured by the camera 11 while moving to the destination, and in a case where the marker appears in the image, the position in the image capturing direction is estimated as the position of a mirror.

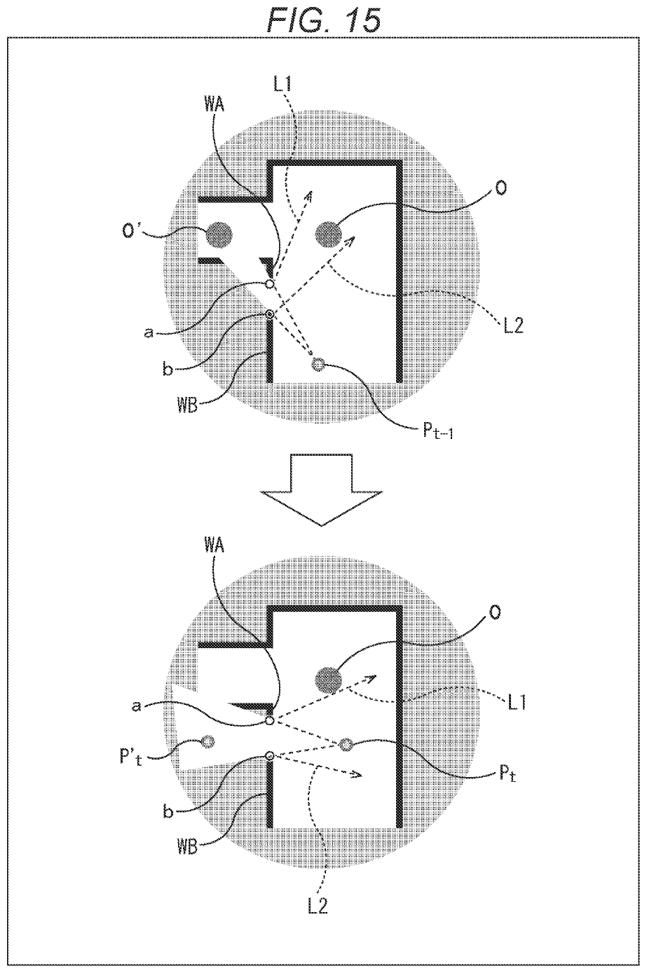

FIG. 15 is a diagram illustrating an example of a method for estimating the position of the mirror.

The occupancy grid map illustrated in an upper part of FIG. 15 is the occupancy grid map representing the same situation as the situation described with reference to FIG. 3. A broken line L1 represents a reflection vector α of light reflected at the end point a, and the broken line L2 represents a reflection vector μ of light reflected at the end point b.

In a case of the situation illustrated in the upper part of FIG. 15, the mobile object 1 has not yet recognized existence of the mirror M between the wall WA and the wall WB. The marker is attached to the housing of the mobile object 1 existing at a position Pₜ₋₁.

In a case where the mobile object 1 moves forward and moves to a position Pₜ as illustrated in the lower part of FIG. 15, the marker appears in the image captured by the camera 11 directed to between the end point a and the end point b. The position Pₜ is a position between the reflection vector α and the reflection vector μ. On the occupancy grid map, it is observed that an object (mobile object 1) is present at the position P′ₜ.

In a case where the marker appears in the image captured by the camera 11, the mobile object 1 recognizes that a mirror is present in the section between the end point a and the end point b detected as the dividing section, and estimates the position of the mirror.

Thus, in a case where the marker appears in the image captured by the camera 11, the mobile object 1 recognizes that a mirror is present in the dividing section in the image capturing direction, and estimates the position of the mirror.

In addition to detecting the marker, the position of the mirror may be estimated on the basis of various analysis results of the image captured in the direction of the dividing section.

For example, it is possible that presence of a mirror in the dividing section is recognized in a case where the mobile object 1 appears in the image captured in the direction to the dividing section. In this case, information regarding appearance characteristics of the mobile object 1 has been given to the mirror position estimation unit 104.

Furthermore, it is possible that matching is performed between characteristics of the image captured in the direction of the dividing section and characteristics of an image captured of a scene in front of the dividing section, and in a case where they match equal to or more than a threshold, presence of the mirror in the dividing section is recognized.

### Configuration Example of Control Unit

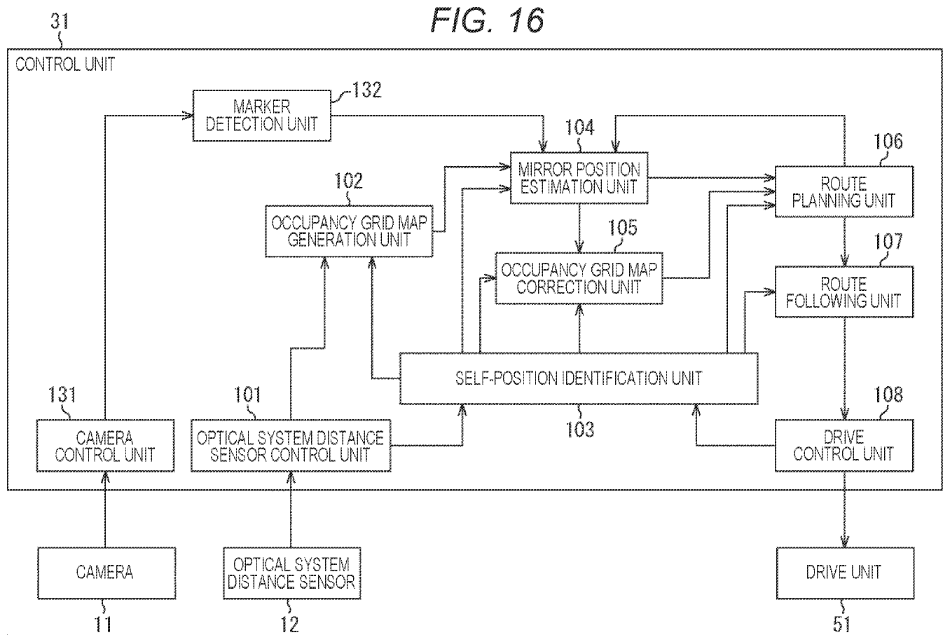

FIG. 16 is a block diagram illustrating a functional configuration example of the control unit 31.

The configuration of the control unit 31 illustrated in FIG. 16 is basically different from the configuration illustrated in FIG. 13 in that a camera control unit 131 and a marker detection unit 132 are provided instead of the ultrasonic sensor control unit 121. Among components illustrated in FIG. 16, the same components as those illustrated in FIG. 13 are designated by the same reference numerals. Duplicate descriptions will be omitted as appropriate.

The camera control unit 131 controls the camera 11 and captures an image of surroundings of the mobile object 1. Image capturing by the camera 11 is repeated at predetermined cycles. The image captured by the camera control unit 131 is output to the marker detection unit 132.

The marker detection unit 132 analyzes the image supplied from the camera control unit 131 and detects a marker appearing in the image. Information indicating a detection result by the marker detection unit 132 is supplied to the mirror position estimation unit 104.

The mirror position estimation unit 104 detects a dividing section, which is a section between end points of a wall, on the basis of the occupancy grid map generated by the occupancy grid map generation unit 102.

In a case where the marker detection unit 132 detects that the marker appears in the image captured in a direction of the dividing section, the mirror position estimation unit 104 recognizes that a mirror is present in the dividing section and estimates the position of the mirror. Information indicating the position of the mirror estimated by the mirror position estimation unit 104 is output to the occupancy grid map correction unit 105 together with the occupancy grid map. Furthermore, information indicating the dividing section and the occupancy grid map are output to the route planning unit 106.

The route planning unit 106 sets the position where the mobile object 1 is to be reflected on the mirror as a destination in a case where it is assumed that a mirror is present in the dividing section. As described above, the position between the reflection vector α and the reflection vector μ is set as the destination. Information of the movement route from the self-position to the destination is output to the route following unit 107.

The route following unit 107 controls the drive control unit 108 so that the mobile object 1 moves to the position where the mobile object 1 is to be reflected in the mirror according to the movement route planned by the route planning unit 106.

### Mirror Position Estimation Process

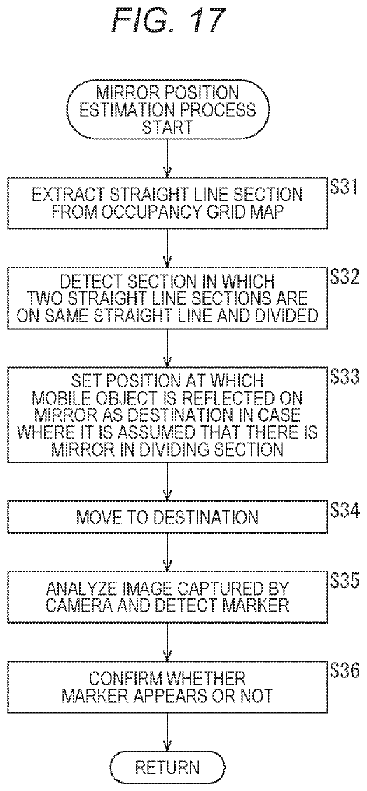

The mirror position estimation process performed in step S3 of FIG. 8 will be described with reference to the flowchart of FIG. 17. The process of FIG. 17 is a process of estimating the position of the mirror using a marker.

The processes of steps S31 and S32 are similar to the processes of steps S21 and S22 of FIG. 14. That is, in step S31, the straight line section is extracted from the occupancy grid map, and in step S32, the dividing section is detected.

In step S33, the route planning unit 106 sets the position at which the mobile object 1 is to be reflected on the mirror as the destination in a case where it is assumed that a mirror is present in the dividing section.

In step S34, the route following unit 107 causes the drive control unit 108 to move the mobile object 1 to the destination.

In step S35, the marker detection unit 132 analyzes the image captured after moving to the destination and detects the marker.

In step S36, the mirror position estimation unit 104 confirms whether or not the marker appears in the image captured in the direction of the dividing section on the basis of the detection result by the marker detection unit 132. In a case where the marker appears in the image, the mirror position estimation unit 104 recognizes that a mirror is present in the dividing section, and outputs information indicating the position of the mirror to the occupancy grid map correction unit 105.

Thereafter, the process returns to step S3 in FIG. 8 and processing in step S3 and subsequent steps is performed.

As described above, the mobile object 1 can estimate the position of the mirror and correct the occupancy grid map by detecting the marker that appears on the image captured by the camera 11.

### Example of Estimating Position of Mirror by Template Matching

### Method for Estimating Position of Mirror

In this example, the position of the mirror is estimated by performing matching of image data of an area in the mirror on the occupancy grid map with image data of a real area.

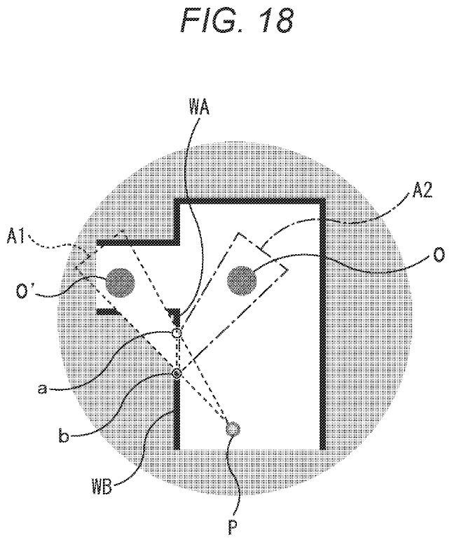

FIG. 18 is a diagram illustrating an example of a method for estimating the position of the mirror.

The occupancy grid map illustrated in FIG. 18 is the occupancy grid map representing the same situation as the situation described with reference to FIG. 3.

In a case of the situation illustrated in FIG. 18, the mobile object 1 has not yet recognized existence of the mirror M between the wall WA and the wall WB. It is recognized that there is a movable area beyond the dividing section between the end point a and the end point b. Furthermore, it is recognized that an object O′ is present ahead of the dividing section.

In this case, the mobile object 1 assumes that an area A1 between an extension line of a straight line connecting the position P that is the self-position and the end point a, and an extension line of a straight line connecting the position P and the end point b, the area being located farther than the dividing section as indicated by surrounding with a broken line, is an area in the mirror.

The mobile object 1 inverts the image data of the area A1 in the entire occupancy grid map so as to be axisymmetric with reference to the straight line connecting the end point a and the end point b, which is the dividing section, and the image data after the inversion is used as a template. The mobile object 1 performs matching of a template with image data of an area A2 indicated by surrounding with an alternate long and short dash line, which is line-symmetric with respect to the area A1.

In a case where the degree of matching between the template and the image data of the area A2 is higher than the threshold, the mobile object 1 recognizes that a mirror is present in the dividing section and estimates the position of the mirror.

In the example of FIG. 18, because the template includes information of the object O′ and the image data of the area A2 includes information of the object O as the entity of the object O′, the degree of matching more than or equal to the threshold is obtained.

Thus, matching of the area in the mirror with the real area is performed, and in a case where those areas match, the mobile object 1 recognizes that a mirror is present in the dividing section and estimates the position of the mirror.

Note that in a case where the template does not include the object used to calculate the degree of matching, the mobile object 1 may move to the position where it will be reflected in the mirror M as described with reference to FIG. 15, and the template may be set and matched on the basis of the occupancy grid map generated in that state.

In this manner, it is possible to arbitrarily set a predetermined area to be used as the template on the occupancy grid map and perform matching with image data of another area to thereby perform estimation of the position of the mirror.

### Configuration Example of Control Unit

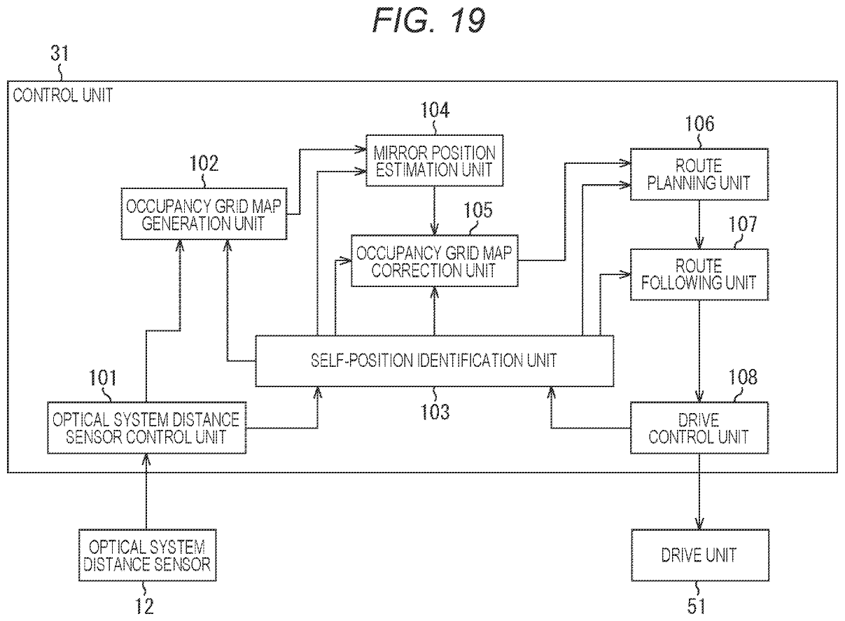

FIG. 19 is a block diagram illustrating a functional configuration example of the control unit 31.

The configuration of the control unit 31 illustrated in FIG. 19 is different from the configuration illustrated in FIG. 16 in that the camera control unit 131 and the marker detection unit 132 are not provided. Among components illustrated in FIG. 19, the same components as those illustrated in FIG. 16 are designated by the same reference numerals. Duplicate descriptions will be omitted as appropriate.

The mirror position estimation unit 104 detects a dividing section, which is a section between end points of a wall, on the basis of the occupancy grid map generated by the occupancy grid map generation unit 102.

The mirror position estimation unit 104 sets the template on the basis of the self-position and the dividing section, and uses image data of an area in the mirror as the template to perform matching with the image data of the real area. In a case where the degree of matching between the template and the image data in the real area is higher than the threshold, the mirror position estimation unit 104 recognizes that a mirror is present in the dividing section and estimates the position of the mirror. Information indicating the position of the mirror estimated by the mirror position estimation unit 104 is output to the occupancy grid map correction unit 105 together with the occupancy grid map.

### Mirror Position Estimation Process

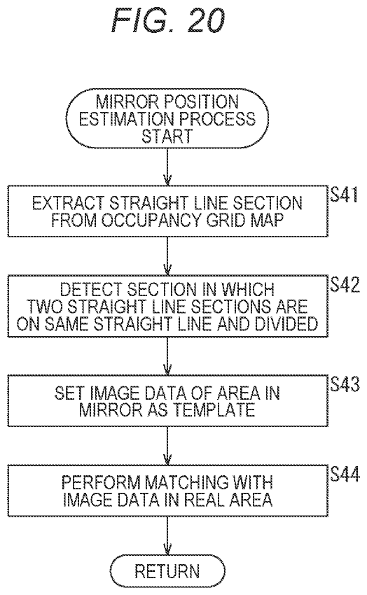

The mirror position estimation process performed in step S3 of FIG. 8 will be described with reference to the flowchart of FIG. 20. The process of FIG. 20 is a process of estimating the position of the mirror by template matching.

The processes of steps S41 and S42 are similar to those of the processes of steps S21 and S22 of FIG. 14. That is, in step S41, the straight line section is extracted from the occupancy grid map, and in step S42, the dividing section is detected.

In step S43, the mirror position estimation unit 104 sets image data of the area in the mirror as the template on the basis of the self-position and the dividing section on the occupancy grid map.

In step S44, the mirror position estimation unit 104 performs matching of the template with image data of the real area. In a case where the degree of matching between the template and the image data of the real area is higher than the threshold, the mirror position estimation unit 104 recognizes that the mirror is present in the dividing section and outputs information indicating the position of the mirror to the occupancy grid map correction unit 105.

Thereafter, the process returns to step S3 in FIG. 8 and processing in step S3 and subsequent steps is performed.

As described above, the mobile object 1 can estimate the position of the mirror and correct the occupancy grid map by matching using the image data of the occupancy grid map.

### Correction of Occupancy Grid Map

Next, correction of the occupancy grid map based on the position of the mirror estimated by each of the above methods will be described.

The correction of the occupancy grid map by the occupancy grid map correction unit 105 is basically performed by two processes of deleting the area in the mirror and obstructing the position of the mirror.

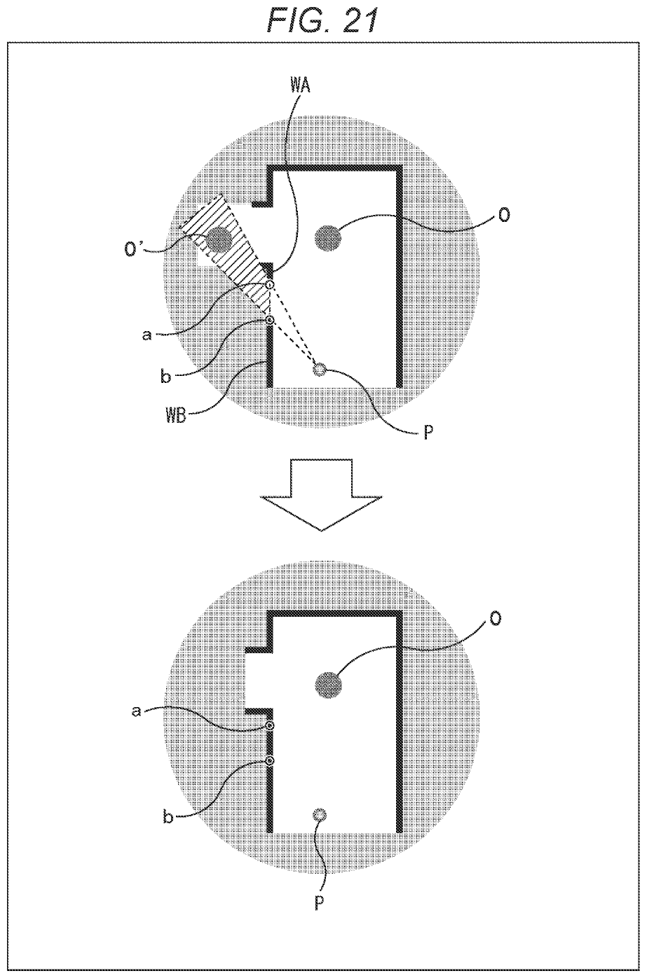

FIG. 21 is a diagram illustrating an example of the correction of the occupancy grid map.

The occupancy grid map illustrated in the upper part of FIG. 21 is the occupancy grid map representing the same situation as the situation described with reference to FIG. 3. The area in the mirror is the area that is between the extension line of the straight line connecting the self-position P and the end point a and the extension line of the straight line connecting the position P and the end point b, and is located farther than the dividing section, as indicated by oblique lines.

In this case, the occupancy grid map correction unit 105 corrects the occupancy grid map so as to delete the area in the mirror. The deleted area is set as an unknown area that has not been observed.

If all directions of the mirror are ignored, in a case where there is an obstacle between the mirror and the observation point (self-position), it will not be possible to detect the obstacle. By leaving the area in front of the section connecting the end point a and the end point b, which is the dividing section, as it is without deleting it from the occupancy grid map, even in a case where there is an obstacle between the mirror and the observation point, the mobile object 1 can reflect information thereof correctly on the occupancy grid map.

Furthermore, the occupancy grid map correction unit 105 corrects the occupancy grid map assuming that a predetermined object is present in the section connecting the end point a and the end point b, which is the dividing section. The occupancy grid map after correction is a map in which the space between the end point a and the end point b is closed as illustrated ahead of a white arrow in FIG. 21.

Thus, the occupancy grid map correction unit 105 can generate an occupancy grid map in which the influence of the mirror is eliminated. By planning the movement route using the occupancy grid map after correction, the mobile object 1 can set a correct route that can actually be passed as the movement route.

### Other Examples

### About Correction when False Detection of Mirror Occurs

There may be an error in estimating the position of the mirror. In a case where the area in the mirror is deleted as described above when the occupancy grid map is corrected, the occupancy grid map correction unit 105 retains data of the deleted area, and restores the occupancy grid map as appropriate on the basis of the retained data.

The restoration of the occupancy grid map is performed, for example, at a timing when it is discovered that the estimation of the position of the mirror is incorrect after correction of the occupancy grid map.

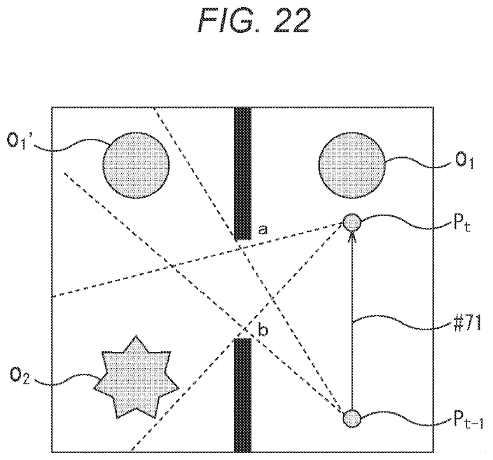

FIG. 22 is a diagram illustrating an example of the restoration of the occupancy grid map.

It is assumed that the area is deleted as described above with the mobile object 1 at the position Pₜ₋₁.

The occupancy grid map correction unit 105 deletes the area that is between the extension line of the straight line connecting a position Pₜ₋₁ and the end point a and the extension line of the straight line connecting the position Pₜ₋₁ and the end point b, and is located farther than the dividing section from the occupancy grid map. Furthermore, the occupancy grid map correction unit 105 retains the data of the area to be deleted. In the example of FIG. 22, it is assumed that the object O1′ is present in an area of deletion symmetry.

It is assumed that the mobile object 1 has moved to the position Pₜ as indicated by arrow #71. At position Pₜ, it is observed that the object O2 is present ahead of the end point a and the end point b. There is a space beyond the end point a and the end point b, which means that the estimation of the position of the mirror was incorrect.

In this case, the occupancy grid map correction unit 105 restores the area deleted from the occupancy grid map on the basis of the retained data. Thus, even in a case where the estimation of the position of the mirror is incorrect, the occupancy grid map correction unit 105 can restore the occupancy grid map so as to represent the situation of the real space discovered later.

### Estimating Position of Other Objects

The case of estimating the position of the mirror and correcting the occupancy grid map has been described, but the estimation of the position of the mirror as described above can be applied in a case of estimating the positions of various objects whose surface is a mirror surface.

Furthermore, the method for estimating the position of the mirror by integrating sensor outputs can also be applied to estimation of the position of an object such as glass having a transparent surface.

In this case, the mobile object 1 integrates the occupancy grid map based on the measurement result by the optical system distance sensor 12 and the occupancy grid map based on the measurement result by the ultrasonic sensor 13, and estimates the position of a transparent object such as an object having a glass surface. In a case where a transparent object is present in the dividing section, the mobile object 1 corrects the occupancy grid map so that the dividing section becomes impassable, and plans the movement route on the basis of the occupancy grid map after correction.

As described above, the above-described estimation of the position of the object can be applied to estimation of the positions of various transparent objects. Note that the position of the transparent object can also be estimated by the method for estimating the position of the mirror on the basis of the prior information.

### About Control System

Although action of the mobile object 1 is controlled by the control unit 31 mounted on the mobile object 1, it may be configured to be controlled by an external device.

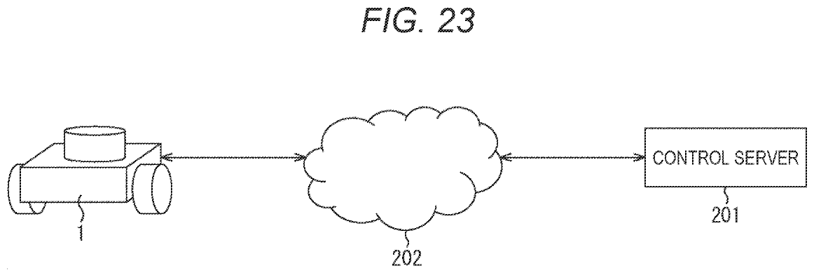

FIG. 23 is a diagram illustrating a configuration example of a control system.

The control system of FIG. 23 is configured by connecting the mobile object 1 and a control server 201 via a network 202 such as the Internet. The mobile object 1 and the control server 201 communicate with each other via the network 202.

In the control system of FIG. 23, the processing of the mobile object 1 as described above is performed by the control server 201, which is an external device of the mobile object 1. That is, each functional unit of the control unit 31 is implemented in the control server 201 by executing a predetermined program.

The control server 201 generates the occupancy grid map as described above on the basis of the distance information transmitted from the mobile object 1, and the like. Various data such as an image captured by the camera 11, distance information detected by the optical system distance sensor 12, and distance information detected by the ultrasonic sensor 13 are repeatedly transmitted from the mobile object 1 to the control server 201.

The control server 201 estimates the position of a mirror as described above, and corrects the occupancy grid map as appropriate. Furthermore, the control server 201 plans the movement route and transmits parameters for moving to a destination to the mobile object 1. The mobile object 1 drives the driving unit 51 according to the parameters transmitted from the control server 201. The control server 201 functions as a control device that controls action of the mobile object 1.

In this manner, the control device that controls action of the mobile object 1 may be provided outside the mobile object 1. Other devices capable of communicating with the mobile object 1, such as a PC, a smartphone, and a tablet terminal, may be used as the control device.

### Configuration Example of Computer

The series of processes described above can be executed by hardware or can be executed by software. In a case where the series of processes is executed by software, a program constituting the software is installed on a computer built into dedicated hardware or a general-purpose personal computer from a program recording medium, or the like.

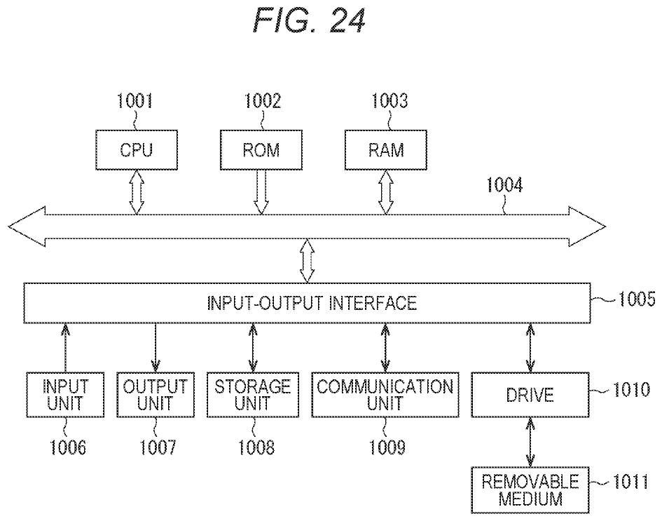

FIG. 24 is a block diagram illustrating a configuration example of hardware of a computer that executes the above-described series of processes by a program. The control server 201 of FIG. 23 also has a configuration similar to that illustrated in FIG. 24.

A central processing unit (CPU) 1001, a read only memory (ROM) 1002, and a random access memory (RAM) 1003 are interconnected via a bus 1004.

An input-output interface 1005 is further connected to the bus 1004. An input unit 1006 including a keyboard, a mouse, and the like, and an output unit 1007 including a display, a speaker, and the like are connected to the input-output interface 1005. Furthermore, the input-output interface 1005 is connected to a storage unit 1008 including a hard disk and a non-volatile memory and the like, a communication unit 1009 including a network interface and the like, and a drive 1010 that drives a removable medium 1011.

In the computer configured as described above, for example, the CPU 1001 loads a program stored in the storage unit 1008 into the RAM 1003 via the input-output interface 1005 and the bus 1004 and executes the program, to thereby perform the above-described series of processes.

For example, the program to be executed by the CPU 1001 is recorded on the removable medium 1011 or provided via a wired or wireless transmission medium such as a local area network, the Internet, or a digital broadcast, and installed in the storage unit 1008.

Note that the program executed by the computer may be a program for processing in time series in the order described in the present description, or a program for processing in parallel or at a necessary timing such as when a call is made.

Furthermore, in the present description, a system means a set of a plurality of components (devices, modules (parts), and the like), and it does not matter whether or not all components are in the same housing. Therefore, both of a plurality of devices housed in separate housings and connected via a network and a single device in which a plurality of modules is housed in one housing are systems.

The effects described herein are merely examples and are not limited, and other effects may be provided.

The embodiments of the present technology are not limited to the above-described embodiments, and various modifications are possible without departing from the gist of the present technology.

For example, the present technology can take a configuration of cloud computing in which one function is shared by a plurality of devices via a network and processed in cooperation.

Furthermore, each step described in the above-described flowcharts can be executed by one device, or can be executed in a shared manner by a plurality of devices.

Moreover, in a case where a plurality of processes is included in one step, the plurality of processes included in the one step can be executed in a shared manner by a plurality of devices in addition to being executed by one device.

### Example of Combinations of Configurations

The present technology can also employ the following configurations.

(1)

A control device including:

a map generation unit that generates a map representing a position occupied by an object on the basis of a detection result by an optical sensor;

an estimation unit that estimates a position of a mirror-surface object that is an object having a mirror surface; and

a route planning unit that plans, in a case where presence of the mirror-surface object is estimated in a dividing section where an arrangement of predetermined objects is divided, a route that does not pass through the dividing section as a movement route of the mobile object on the basis of the map.

(2)

The control device according to (1) above, in which

the optical sensor is a distance sensor that measures a distance to an object on the basis of a reflected light of an emitted light.

(3)

The control device according to (2) above, in which

the estimation unit estimates the position of the mirror-surface object on the basis of a detection result by another sensor that targets at the dividing section and measures a distance to the object by a method different from a method that is used by the optical sensor.

(4)

The control device according to (3) above, in which

the estimation unit estimates the position of the mirror-surface object on the basis of a detection result by an ultrasonic sensor as the another sensor.

(5)

The control device according to (4) above, in which

in a case where the detection result by the ultrasonic sensor indicates presence of an object, the estimation unit estimates that the mirror-surface object is present in the dividing section.

(6)

The control device according to (1) or (2) above, in which

the estimation unit estimates the position of the mirror-surface object on the basis of an image obtained by capturing an image of a position of the dividing section.

(7)

The control device according to (6) above, in which

in a case where a predetermined identifier attached to a surface of the mobile object appears in the image, the estimation unit estimates that the mirror-surface object is present in the dividing section.

(8)

The control device according to (6) or (7) above, in which

the estimation unit estimates that the mirror-surface object is present on the basis of the image that is captured in a state that a position of the mobile object on the map is between reflection vectors of vectors directed from the position of the mobile object to both ends of the dividing section.

(9)

The control device according to (8) above, further including

a drive control unit that causes the mobile object to move to a position between the reflection vectors.

(10)

The control device according to (1) or (2) above, in which

the estimation unit estimates the position of the mirror-surface object on the basis of a matching result between image data of a predetermined area on the map and image data of another area.

(11)

The control device according to (10) above, in which

the estimation unit sets an area ahead of the dividing section as the predetermined area with reference to a position of the mobile object.

(12)

The control device according to (11) above, in which

the estimation unit performs matching of the image data of the predetermined area with the image data of an area that is the another area and is line-symmetric with respect to the predetermined area when the dividing section is used as a reference.

(13)

The control device according to any one of (1) to (12) above, further including

a map correction unit that corrects the map in a case where the estimation unit estimates that the mirror-surface object is present,

in which the route planning unit plans the movement route on the basis of the map corrected by the map correction unit.

(14)

The control device according to any one of (1) to (13) above, in which

the control device is a device mounted on the mobile object.

(15)

An information processing method including, by a control device:

generating a map representing a position occupied by an object on the basis of a detection result by an optical sensor;

estimating a position of a mirror-surface object that is an object having a mirror surface; and

planning, in a case where presence of the mirror-surface object is estimated in a dividing section where an arrangement of predetermined objects is divided, a route that does not pass through the dividing section as a movement route of the mobile object on the basis of the map.

(16)

A program for causing a computer to execute a process, the process including:

generating a map representing a position occupied by an object on the basis of a detection result by an optical sensor;

estimating a position of a mirror-surface object that is an object having a mirror surface; and

planning, in a case where presence of the mirror-surface object is estimated in a dividing section where an arrangement of predetermined objects is divided, a route that does not pass through the dividing section as a movement route of the mobile object on the basis of the map.

(17)

A control device including

a map generation unit that generates a map representing a position occupied by an object on the basis of a detection result by an optical sensor;

an estimation unit that estimates a position of a transparent object, which is an object having a transparent surface, on the basis of a detection result by another sensor that measures a distance to an object by a method different from a method used by the optical sensor; and

a route planning unit that plans, in a case where presence of the transparent object is estimated in a dividing section where an arrangement of predetermined objects is divided, a route that does not pass through the dividing section as a movement route of the mobile object on the basis of the map.

### REFERENCE SIGNS LIST

1 Mobile object

11 Camera

12 Optical system distance sensor

13 Ultrasonic sensor

31 Control unit

101 Optical system distance sensor control unit

102 Occupancy grid map generation unit

103 Self-position identification unit

104 Mirror position estimation unit

105 Occupancy grid map correction unit

106 Route Planning Unit

107 Route following unit

108 Drive control unit

109 Mirror position information storage unit

121 Ultrasonic sensor control unit

131 Camera control unit

132 Marker detection unit

1. A control device comprising:
a map generation unit that generates a map representing a position occupied by an object on a basis of a detection result by an optical sensor;
an estimation unit that estimates a position of a mirror-surface object that is an object having a mirror surface; and
a route planning unit that plans, in a case where presence of the mirror-surface object is estimated in a dividing section where an arrangement of predetermined objects is divided, a route that does not pass through the dividing section as a movement route of the mobile object on a basis of the map.

2. The control device according to claim 1, wherein
the optical sensor is a distance sensor that measures a distance to an object on a basis of a reflected light of an emitted light.

3. The control device according to claim 2, wherein
the estimation unit estimates the position of the mirror-surface object on a basis of a detection result by another sensor that targets at the dividing section and measures a distance to the object by a method different from a method that is used by the optical sensor.

4. The control device according to claim 3, wherein
the estimation unit estimates the position of the mirror-surface object on a basis of a detection result by an ultrasonic sensor as the another sensor.

5. The control device according to claim 4, wherein
in a case where the detection result by the ultrasonic sensor indicates presence of an object, the estimation unit estimates that the mirror-surface object is present in the dividing section.

6. The control device according to claim 1, wherein
the estimation unit estimates the position of the mirror-surface object on a basis of an image obtained by capturing an image of a position of the dividing section.

7. The control device according to claim 6, wherein
in a case where a predetermined identifier attached to a surface of the mobile object appears in the image, the estimation unit estimates that the mirror-surface object is present in the dividing section.

8. The control device according to claim 7, wherein
the estimation unit estimates that the mirror-surface object is present on a basis of the image that is captured in a state that a position of the mobile object on the map is between reflection vectors of vectors directed from the position of the mobile object to both ends of the dividing section.

9. The control device according to claim 8, further comprising
a drive control unit that causes the mobile object to move to a position between the reflection vectors.

10. The control device according to claim 1, wherein
the estimation unit estimates the position of the mirror-surface object on a basis of a matching result between image data of a predetermined area on the map and image data of another area.

11. The control device according to claim 10, wherein
the estimation unit sets an area ahead of the dividing section as the predetermined area with reference to a position of the mobile object.

12. The control device according to claim 11, wherein
the estimation unit performs matching of the image data of the predetermined area with the image data of an area that is the another area and is line-symmetric with respect to the predetermined area when the dividing section is used as a reference.

13. The control device according to claim 1, further comprising
a map correction unit that corrects the map in a case where the estimation unit estimates that the mirror-surface object is present,
wherein the route planning unit plans the movement route on a basis of the map corrected by the map correction unit.

14. The control device according to claim 1, wherein
the control device is a device mounted on the mobile object.

15. An information processing method comprising, by a control device:
generating a map representing a position occupied by an object on a basis of a detection result by an optical sensor;
estimating a position of a mirror-surface object that is an object having a mirror surface; and
planning, in a case where presence of the mirror-surface object is estimated in a dividing section where an arrangement of predetermined objects is divided, a route that does not pass through the dividing section as a movement route of the mobile object on a basis of the map.

16. A program for causing a computer to execute a process, the process comprising:
generating a map representing a position occupied by an object on a basis of a detection result by an optical sensor;
estimating a position of a mirror-surface object that is an object having a mirror surface; and
planning, in a case where presence of the mirror-surface object is estimated in a dividing section where an arrangement of predetermined objects is divided, a route that does not pass through the dividing section as a movement route of the mobile object on a basis of the map.

17. A control device comprising:
a map generation unit that generates a map representing a position occupied by an object on a basis of a detection result by an optical sensor;
an estimation unit that estimates a position of a transparent object, which is an object having a transparent surface, on a basis of a detection result by another sensor that measures a distance to an object by a method different from a method used by the optical sensor; and
a route planning unit that plans, in a case where presence of the transparent object is estimated in a dividing section where an arrangement of predetermined objects is divided, a route that does not pass through the dividing section as a movement route of the mobile object on a basis of the map.
